(19) United States
(12) Patent Application Publication
(10) Pub. No.: US 2009/0279717 A1
(43) Pub. Date: Nov. 12, 2009

(54) Circuit module for a condenser microphone

(75) Inventor: Chien-Chin Hsiao, Hsinchu City (TW)

Correspondence Address: NIXON & VANDERHYE, PC, 901 NORTH GLEBE ROAD, 11TH FLOOR, ARLINGTON, VA, 22203, US

(73) Assignee: UDID TECHNOLOGY CO., LTD., Sindian City (TW)

(21) Appl. No.: 12/149,995

(22) Filed: May 12, 2008

(51) Int. Cl. H04R 3/06

(52) U.S. Cl. 381/113

(57) ABSTRACT

A circuit module for a condenser microphone includes a first chip mounted on a mounting surface of a printed circuit board and including an impedance converter circuit for amplifying an electrical signal received from a capacitive sensor via a first conductive pattern on the mounting surface and for outputting an amplified electrical signal. A second chip is mounted on the mounting surface of the printed circuit board, and includes a filtering circuit for filtering the amplified electrical signal received from the first chip via a conductive wire unit and a second conductive pattern on the mounting surface. The first chip and the second chip are further coupled to a ground pattern on the mounting surface.

### BACKGROUND OF THE INVENTION

1. Field of the Invention

The invention relates to a circuit module, more particularly to a circuit module for a condenser microphone.

2. Description of the Related Art

Referring to FIG. 1, a conventional condenser microphone is shown to include a capacitive sensor 7, an impedance converter 8, and a filtering unit 9. The capacitive sensor 7 generates an electrical signal corresponding to an external sound wave signal during vibration thereof in response to the external sound wave signal. The impedance converter 8 is coupled to the capacitive sensor 7, and includes a field effect transistor (not shown) for amplifying the electrical signal received from the capacitive sensor 7. The filtering unit 9 is coupled to the impedance converter 8 for filtering the electrical signal amplified by the impedance converter 8.

FIG. 2 illustrates a conventional circuit module for a condenser microphone that includes a bare chip 61 packaged directly on a circular printed circuit board 63. The bare chip 61 is integrated with the impedance converter 8 and the filtering unit 9 as shown in FIG. 1. In such a configuration, the conventional circuit module has a fixed specification. If the conventional circuit module is required to have a higher filtering quality, the bare chip must be redesigned to meet the desired requirement.

### SUMMARY OF THE INVENTION

Therefore, an object of the present invention is to provide a circuit module for a condenser microphone that can overcome the aforesaid drawbacks of the prior art.

According to the present invention, there is provided a circuit module for a condenser microphone. The condenser microphone includes a capacitive sensor for generating an electrical signal corresponding to an external sound wave signal during vibration thereof in response to the external sound wave signal. The circuit module comprises:

a printed circuit board having a mounting surface formed with a first conductive pattern, a second conductive pattern and a ground pattern spaced apart from each other, the first conductive pattern being adapted to be coupled to the capacitive sensor;

a first chip mounted on the mounting surface of the printed circuit board, and having an input terminal, an output terminal and a ground terminal coupled respectively to the first conductive pattern, the second conductive pattern and the ground pattern of the printed circuit board, the first chip including an impedance converter circuit adapted for amplifying the electrical signal received from the capacitive sensor via the first conductive pattern of the printed circuit board and for outputting an amplified electrical signal at the output terminal; and

a second chip mounted on the mounting surface of the printed circuit board and having a first terminal unit, a second terminal, and a conductive wire unit for connecting electrically and respectively the first terminal unit and the second terminal to the second conductive pattern and the ground pattern of the printed circuit board, the second chip including a filtering circuit for filtering the amplified electrical signal received from the output terminal of the first chip via the second conductive pattern.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram illustrating a conventional condenser microphone;

FIG. 2 is a schematic top view of a conventional circuit module for a condenser microphone;

FIG. 3 is a schematic top view showing the first preferred embodiment of a circuit module for a condenser microphone according to the present invention;

FIG. 4 illustrates an electrical circuit diagram of a first chip of the first preferred embodiment;

FIG. 5 illustrates an electrical circuit diagram of a second chip of the first preferred embodiment;

FIG. 6 illustrates an electrical circuit diagram of a first modified example of the second chip of the first preferred embodiment;

FIG. 7 illustrates an electrical circuit diagram of a second modified example of the second chip of the first preferred embodiment;

FIG. 8 illustrates an electrical circuit diagram of a third modified example of the second chip of the first preferred embodiment;

FIG. 9 illustrates an electrical circuit diagram of a fourth modified example of the second chip of the first preferred embodiment;

FIG. 10 is a schematic top view showing the second preferred embodiment of a circuit module for a condenser microphone according to the present invention;

FIG. 11 illustrates an equivalent electrical circuit diagram of the second preferred embodiment;

FIG. 12 illustrates an electrical circuit diagram of a second chip of the second preferred embodiment;

FIG. 13 illustrates an electrical circuit diagram of a first modified example of the second chip of the second preferred embodiment;

FIG. 14 illustrates an electrical circuit diagram of a second modified example of the second chip of the second preferred embodiment;

FIG. 15 illustrates an electrical circuit diagram of a third modified example of the second chip of the second preferred embodiment;

FIG. 16 illustrates an electrical circuit diagram of a fourth modified example of the second chip of the second preferred embodiment;

FIG. 17 is a schematic top view showing the third preferred embodiment of a circuit module for a condenser microphone according to the present invention; and

FIG. 18 illustrates an equivalent electrical circuit diagram of the third preferred embodiment.

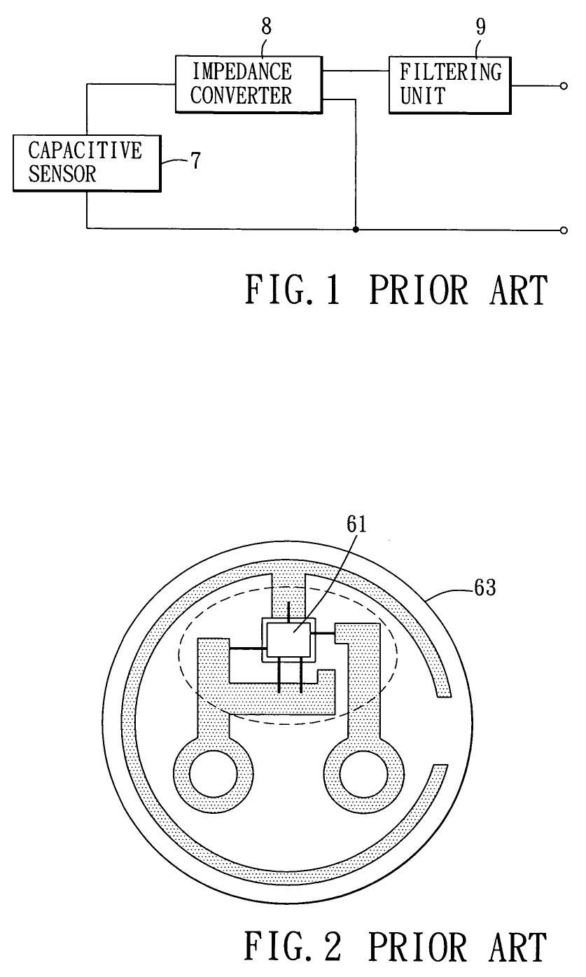

### DETAILED DESCRIPTION OF THE PREFERRED EMBODIMENTS

Before the present invention is described in greater detail, it should be noted that like elements are denoted by the same reference numerals throughout the disclosure.

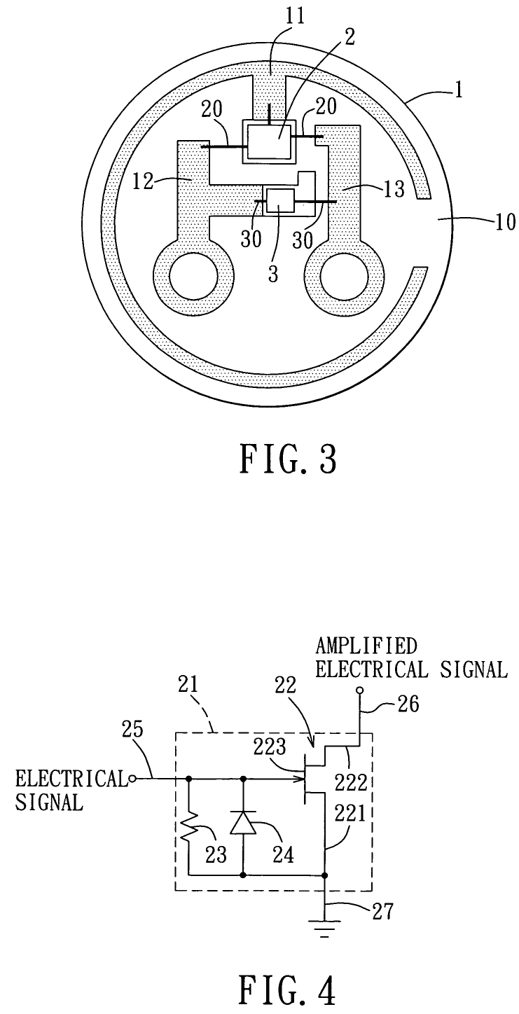

Referring to FIG. 3, the first preferred embodiment of a circuit module for a condenser microphone (not shown) according to the present invention is shown to include a printed circuit board 1, a first chip 2, and a second chip 3. The condenser microphone includes a capacitive sensor (not shown) for generating an electrical signal corresponding to an external sound wave signal during vibration thereof in response to the external sound wave signal. Since the feature of this invention does not reside in the configuration of the capacitive sensor, which is conventional, details of the same are omitted herein for the sake of brevity.

The printed circuit board 1 is circular, and has a mounting surface 10 that is formed with a first conductive pattern 11, a second conductive pattern 12 and a ground pattern 13 spaced apart from each other. The first conductive pattern 11 is adapted to be coupled to the capacitive sensor. Each of the first and second conductive patterns 11, 12 and the ground pattern 13 is made of copper foil.

Referring further to FIG. 4, in this embodiment, the first chip 2, such as an analog integrated circuit chip, is a bare chip, that is packaged directly on the mounting surface 10 of the printed circuit board 1, and has an input terminal 25, an output terminal 26, a ground terminal 27, and three conductive wires 20 connecting electrically and respectively the input, output and ground terminals 25, 26, 27 to the first conductive pattern 11, the second conductive pattern 12 and the ground pattern 13 of the printed circuit board 1 using known wire bonding techniques. In other embodiments, the first chip 2 can be a digital integrated circuit chip. The first chip 2 includes an impedance converter circuit adapted for amplifying the electrical signal received from the capacitive sensor via the first conductive pattern 11 of the printed circuit board 1 and a corresponding one of the conductive wires 20 and for outputting an amplified electrical signal at the output terminal 26. The impedance converter circuit includes a linear amplifier, such as one constructed from a Junction field effect transistor (JFET) 22, a resistor 23, and a diode 24. The JFET 22 has a source 221 coupled to the ground terminal 27 of the first chip 2, a drain 222 coupled to the output terminal 26 of the first chip 2, and a gate 223 coupled to the input terminal 25 of the first chip 2. The resistor 23 is coupled between the input and ground terminals 25, 27 of the first chip 2. The diode 24 has an anode coupled to the ground terminal 27 of the first chip 2, and a cathode coupled to the input terminal 25 of the first chip 2.

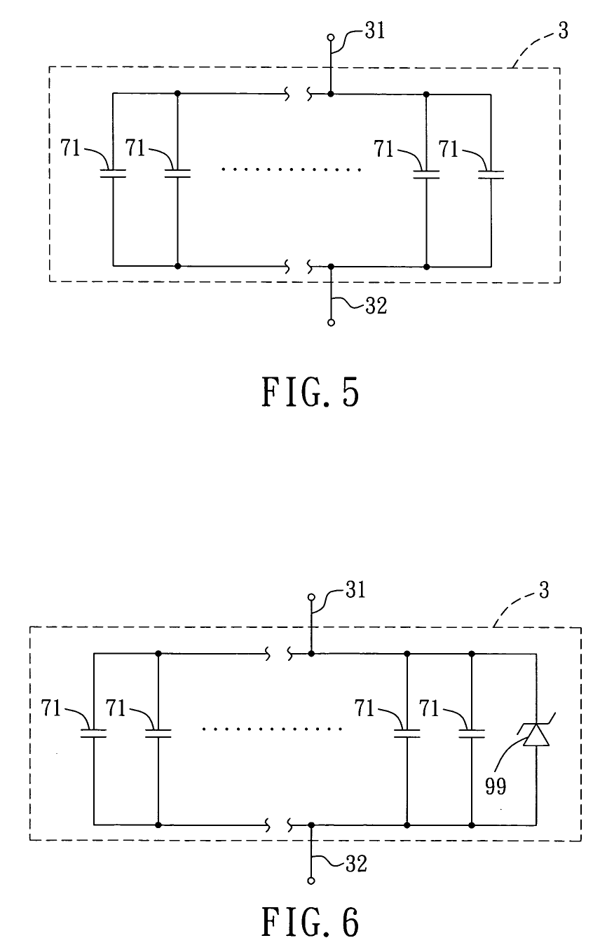

Referring further to FIG. 5, the second chip 3 is a bare chip, that is packaged directly on the mounting surface 10 of the printed circuit board 1, and has a first terminal unit, a second terminal 32, and a conductive wire unit for connecting electrically the first terminal unit and the second terminal 32 to the second conductive pattern 12 and the ground pattern 13 of the printed circuit board 1. The second chip 3 includes a filtering circuit for filtering the amplified electrical signal received from the output terminal 26 of the first chip 2 via the second conductive pattern 12 of the printed circuit board 1. In this embodiment, the first terminal unit has only one first terminal 31. The conductive wire unit has two conductive wires 30. The filtering circuit includes a plurality of filtering units, each of which includes a capacitor 71 in this embodiment, coupled between the first and second terminals 31, 32 of the second chip 3.

FIG. 6 shows a first modified example of the second chip 3 of the first preferred embodiment. Unlike the second chip 3 of FIG. 5, the filtering circuit further includes a semiconductor element, such as a Zener diode 99, coupled between the first and second terminals 31, 32 for preventing electrostatic discharge. In other embodiments, the semiconductor element can be a TVS diode or a thyristor.

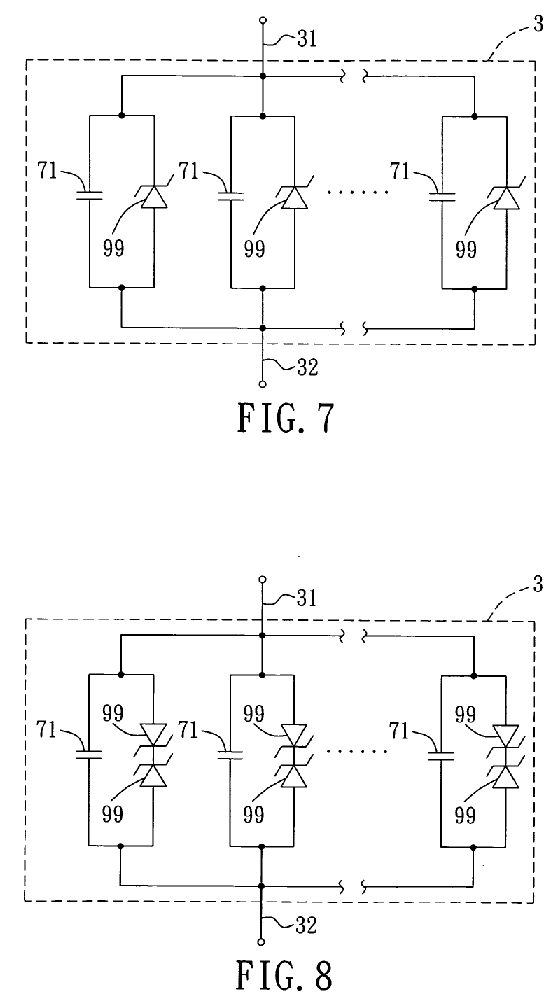

FIG. 7 shows a second modified example of the second chip 3 of the first preferred embodiment. Unlike the second chip 3 of FIG. 5, each filtering unit of the filtering circuit further includes a semiconductor unit coupled in parallel to the capacitor 71 for preventing electrostatic discharge. In this example, the semiconductor unit includes a Zener diode. In other embodiments, the semiconductor unit can be a TVS diode or a thyristor.

FIG. 8 shows a third modified example of the second chip 3 of the first preferred embodiment. Unlike the second chip 3 of FIG. 7, the semiconductor unit of each filtering unit of the filtering circuit includes two Zener diodes 99 connected invertedly in series.

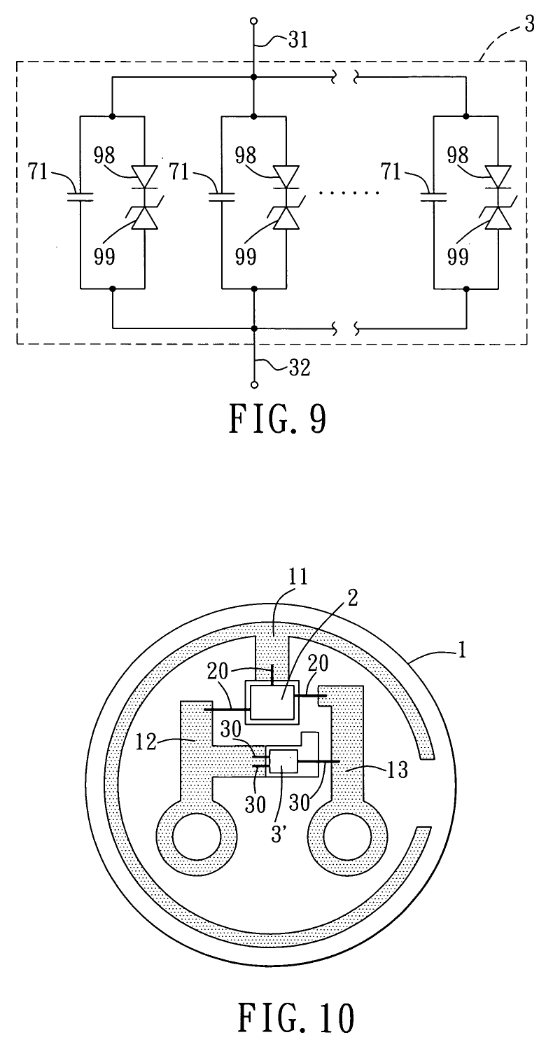

FIG. 9 shows a fourth modified example of the second chip 3 of the first preferred embodiment. Unlike the second chip 3 of FIG. 7, the semiconductor unit of each filtering unit of the filtering circuit includes a series connection of a diode 98 and a Zener diode 99. In other embodiments, the semiconductor unit of each filtering unit of the filtering circuit can be a series connection of the diode 98 and one of a TVS diode and a thyristor.

FIGS. 10 to 12 illustrate the second preferred embodiment of a circuit module for a condenser microphone according to this invention, which is a modification of the first preferred embodiment. In this embodiment, the first terminal unit of the second chip 3′ includes a plurality of terminals 33. The filtering circuit includes a plurality of filtering units each having a first end coupled to the second terminal 32 of the second chip 3′, and a second end coupled to a corresponding one of the terminals 33 of the first terminal unit of the second chip 3′. In this embodiment, each filtering unit of the filtering circuit of the second chip 3′ includes a capacitor 71. Furthermore, the conductive wire unit of the second chip 3′ includes three conductive wires 30, two of which interconnect electrically and respectively two selected ones of the terminals 33 of the first terminal unit of the second chip 3′ and the second conductive pattern 12 of the printed circuit board 1, and the other one of which interconnects electrically the second terminal 32 of the second chip 3′ and the ground pattern 13 of the printed circuit board 1.

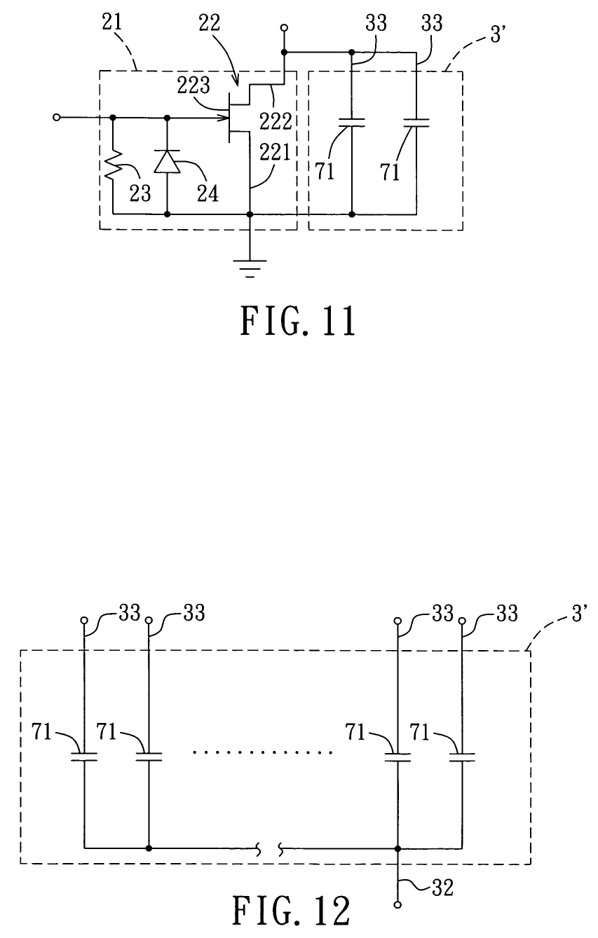

FIG. 13 shows a first modified example of the second chip 3′ of the second preferred embodiment. Unlike the second chip 3′ of FIG. 12, the filtering circuit further includes a semiconductor element, such as a Zener diode 99, coupled between a corresponding one of the terminals 33 of the first terminal unit and the second terminal 32 for preventing electrostatic discharge. The corresponding one of the terminals 33 of the first terminal unit coupled to the semiconductor element is connected electrically to the second conductive pattern 12 of the printed circuit board 1 by means of the conductive wire unit. In other embodiments, the semiconductor element can be a TVS diode or a thyristor.

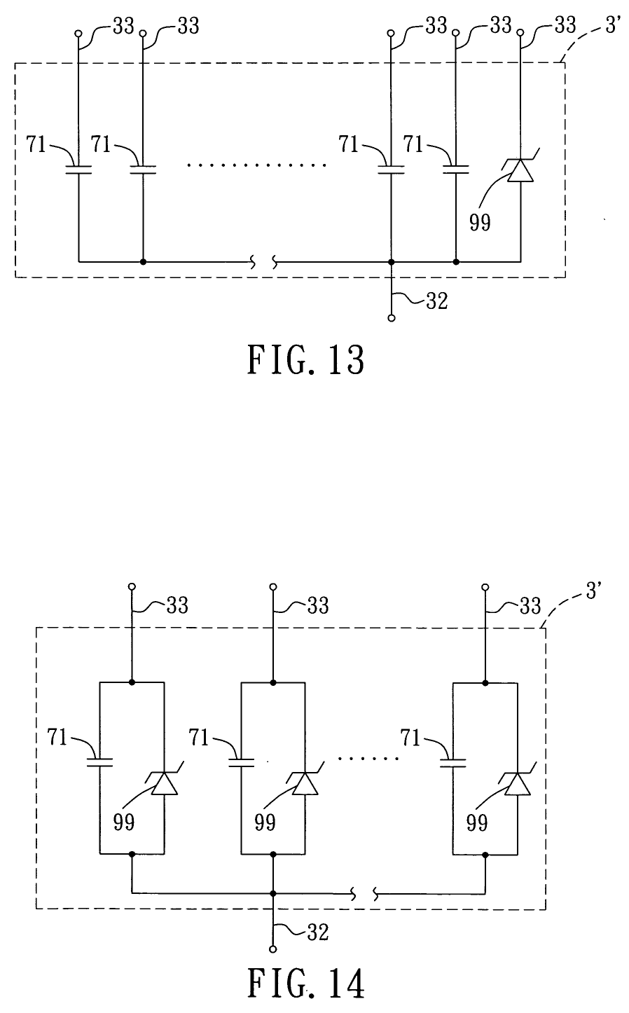

FIG. 14 shows a second modified example of the second chip 3′ of the second preferred embodiment. Unlike the second chip 3′ of FIG. 12, each filtering unit of the filtering circuit further includes a semiconductor unit coupled in parallel to the capacitor 71 for preventing electrostatic discharge. In this example, the semiconductor unit includes a Zener diode. In other embodiments, the semiconductor unit can be a TVS diode or a thyristor.

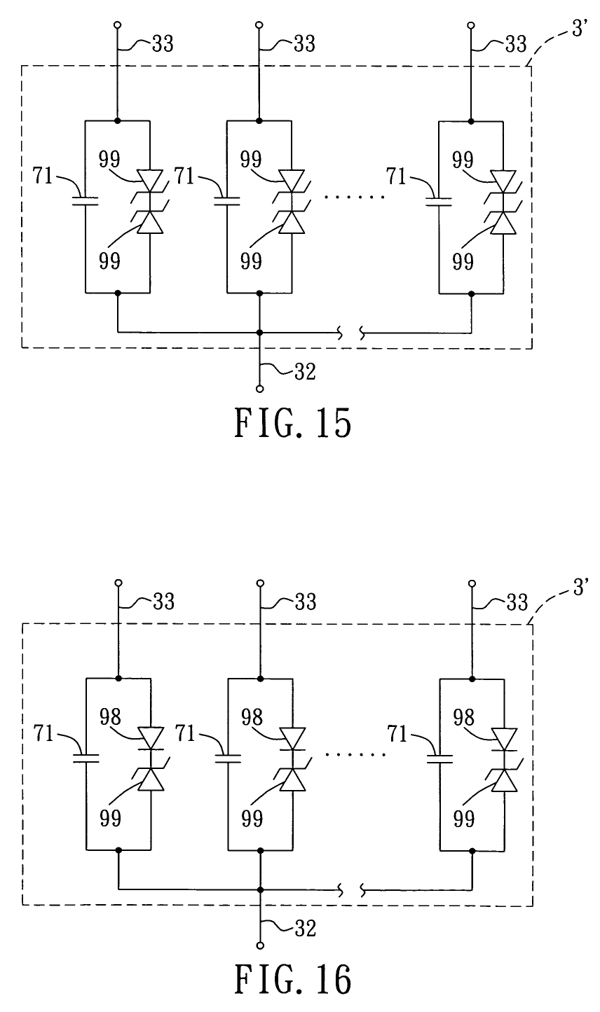

FIG. 15 shows a third modified example of the second chip 3′ of the second preferred embodiment. Unlike the second chip 3′ of FIG. 14, the semiconductor unit of each filtering unit of the filtering circuit includes two Zener diodes 99 connected invertedly in series.

FIG. 16 shows a fourth modified example of the second chip 3′ of the second preferred embodiment. Unlike the second chip 3′ of FIG. 14, the semiconductor unit of each filtering unit of the filtering circuit includes a series connection of a diode 98 and a Zener diode 99. In other embodiments, the semiconductor unit of each filtering unit of the filtering circuit can be a series connection of the diode 98 and one of a TVS diode and a thyristor.

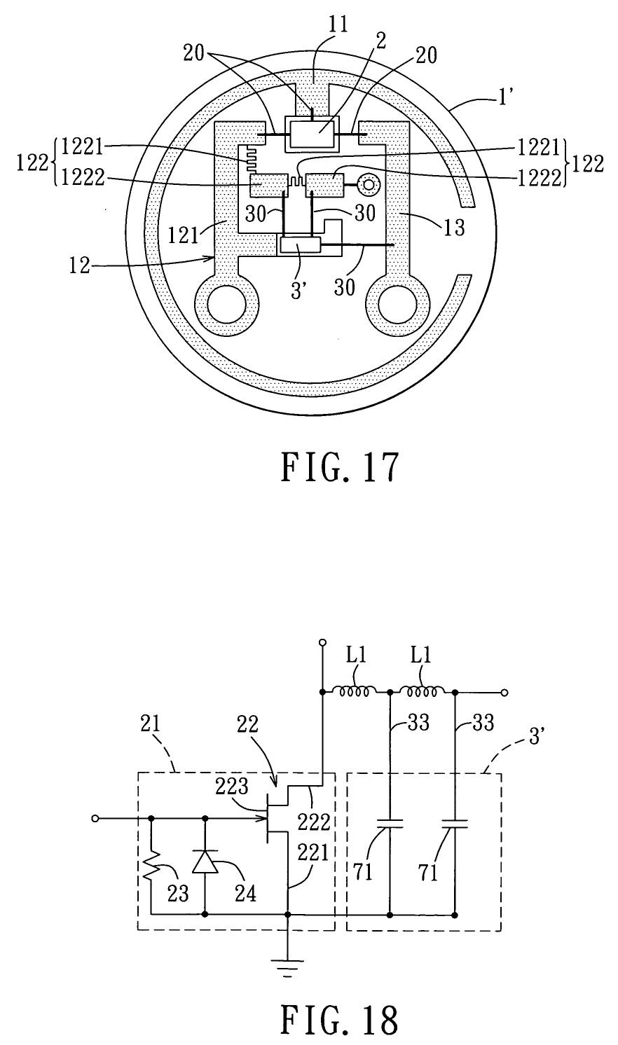

FIGS. 17 and 18 illustrate the third preferred embodiment of a circuit module for a condenser microphone according to this invention, which is a modification of the second preferred embodiment. In this embodiment, the second conductive pattern 12′ of the printed circuit board 1′ includes a main pattern portion 121, and a series connection of two auxiliary pattern portions 122 connected integrally to the main pattern portion 121. Each auxiliary pattern portion 122 has an inductor section 1221 serving as an inductor (L1) as shown in FIG. 18, and a conducting section 1222 connected integrally to the inductor section 1221. The inductor section 1221 of one of the auxiliary pattern portions 122 is connected integrally to the main pattern portion 121. The inductor section 1221 of the other one of the auxiliary pattern portions 122 is connected integrally to the conducting section 1222 of said one of the auxiliary pattern portions 122. Two of the conductive wires 30 of the conductive wire unit interconnect electrically and respectively the two selected ones of the terminals 33 of the first terminal unit of the second chip 3′ and the conducting sections 1222 of the auxiliary pattern portions 122 of the second conductive pattern 12′ of the printed circuit board 1′.

It is noted that the specification of the second chip 3′ of the second and third preferred embodiments can be reconfigured through the conductive wires 33 of the conductive wire unit that interconnect electrically the first terminal unit of the second chip 3′ and the second conductive pattern 12, 12′ of the printed circuit board 1, 1′.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A circuit module for a condenser microphone, the condenser microphone including a capacitive sensor for generating an electrical signal corresponding to an external sound wave signal during vibration thereof in response to the external sound wave signal, said circuit module comprising:
a printed circuit board having a mounting surface formed with a first conductive pattern, a second conductive pattern and a ground pattern spaced apart from each other, said first conductive pattern being adapted to be coupled to the capacitive sensor;
a first chip mounted on said mounting surface of said printed circuit board, and having an input terminal, an output terminal and a ground terminal coupled respectively to said first conductive pattern, said second conductive pattern and said ground pattern of said printed circuit board, said first chip including an impedance converter circuit adapted for amplifying the electrical signal received from the capacitive sensor via said first conductive pattern of said printed circuit board and for outputting an amplified electrical signal at said output terminal; and
a second chip mounted on said mounting surface of said printed circuit board and having a first terminal unit, a second terminal, and a conductive wire unit for connecting electrically and respectively said first terminal unit and said second terminal to said second conductive pattern and said ground pattern of said printed circuit board, said second chip including a filtering circuit for filtering the amplified electrical signal received from said output terminal of said first chip via said second conductive pattern of said printed circuit board.

2. The circuit module as claimed in claim 1, wherein said first chip is a digital integrated circuit chip.

3. The circuit module as claimed in claim 1, wherein said first chip is an analog integrated circuit chip, said impedance converter circuit including a linear amplifier.

4. The circuit module as claimed in claim 1, wherein said impedance converter circuit of said first chip includes:
a junction field effect transistor having a source coupled to said ground terminal of said first chip, a drain coupled to said output terminal of said first chip, and a gate coupled to said input terminal;
a resistor coupled between said input and ground terminals of said first chip; and
a diode having an anode coupled to said ground terminal of said first chip, and a cathode coupled to said input terminal of said first chip.

5. The circuit module as claimed in claim 1, wherein each of said first and second chips is a bare chip, and is packaged directly on said mounting surface of said printed circuit board.

6. The circuit module as claimed in claim 5, further comprising three conductive wires that connect electrically and respectively said input terminal, said output terminal and said ground terminal of said first chip to said first conductive pattern, said second conductive pattern and said ground pattern of said printed circuit board.

7. The circuit module as claimed in claim 5, wherein said filtering circuit of said second chip includes at least one filtering unit coupled between said first terminal unit and said second terminal.

8. The circuit module as claimed in claim 7, wherein said filtering circuit of said second chip further includes a semiconductor element coupled between said first terminal unit and said second terminal for preventing electrostatic discharge.

9. The circuit module as claimed in claim 8, wherein said semiconductor element includes one of a Zener diode, a TVS diode and a thyristor.

10. The circuit module as claimed in claim 7, wherein said filtering circuit of said second chip includes a plurality of said filtering units, each including a capacitor.

11. The circuit module as claimed in claim 10, wherein each of said filtering units of said filtering circuit of said second chip further includes a semiconductor unit coupled in parallel to said capacitor for preventing electrostatic discharge.

12. The circuit module as claimed in claim 11, wherein said semiconductor unit of each of said filtering units of said filtering circuit of said second chip includes at least one of a Zener diode, a TVS diode and a thyristor.

13. The circuit module as claimed in claim 11, wherein said semiconductor unit of each of said filtering units of said second chip includes a series connection of a diode and one of a Zener diode, a TVS diode and a thyristor.

14. The circuit module as claimed in claim 5, wherein:
said first terminal unit of said second chip includes a plurality of terminals;
said filtering circuit of said second chip includes a plurality of filtering units each having a first end coupled to said second terminal of said second chip, and a second end coupled to a corresponding one of said terminals of said first terminal unit of said second chip; and
said conductive wire unit of said second chip includes at least one conductive wire interconnecting electrically a selected one of said terminals of said first terminal unit of said second chip and said second conductive pattern of said printed circuit board.

15. The circuit module as claimed in claim 14, wherein said filtering circuit of said second chip further includes a semiconductor element coupled between a corresponding one of said terminals of said first terminal unit and said second terminal for preventing electrostatic discharge, the corresponding one of said terminals of said first terminal unit coupled to said semiconductor element being connected electrically to said second conductive pattern of said printed circuit board by means of said conductive wire unit.

16. The circuit module as claimed in claim 15, wherein said semiconductor element includes one of a Zener diode, a TVS diode and a thyristor.

17. The circuit module as claimed in claim 14, wherein each of said filtering units of said filtering circuit of said second chip includes a capacitor.

18. The circuit module as claimed in claim 17, wherein each of said filtering units of said filtering circuit of said second chip further includes a semiconductor unit coupled in parallel to said capacitor for preventing electrostatic discharge.

19. The circuit module as claimed in claim 18, wherein said semiconductor unit of each of said filtering units of said second chip includes at least one of a Zener diode, a TVS diode and a thyristor.

20. The circuit module as claimed in claim 18, wherein said semiconductor unit of each of said filtering units of said second chip includes a series connection of a diode and one of a Zener diode, a TVS diode and a thyristor.

21. The circuit module as claimed in claim 17, wherein:
said second conductive pattern of said printed circuit board includes a main pattern portion, and at least one auxiliary pattern portion connected integrally to said main pattern portion, said auxiliary pattern portion having an inductor section connected integrally to said main pattern portion, and a conducting section connected integrally to said inductor section; and
said conductive wire unit interconnects electrically the selected one of said terminals of said first terminal unit of said second chip and said conducting section of said auxiliary pattern portion of said second conductive pattern of said printed circuit board.
